(19) United States
(12) Patent Application Publication
(10) Pub. No.: US 2026/0184429 A1
(43) Pub. Date: Jul. 2, 2026

(54) FLEXIBLE DOOR FOR AIRCRAFT SEAT UNIT

(71) Applicant: AIRBUS ATLANTIC SAS, ROCHEFORT (FR)

(72) Inventor: Laurent VIGNON, ROCHEFORT (FR)

(21) Appl. No.: 18/868,238

(22) PCT Filed: May 24, 2023
(86) PCT No.: PCT/FR2023/050736

§ 371 Date: Nov. 22, 2024

(30) Foreign Application Priority Data
May 25, 2022 (FR) 2205029

(51) Int. Cl. B64D 11/06; B64C 1/14

(52) U.S. Cl. CPC B64D 11/0606; B64C 1/1438; B64C 1/1461

(57) ABSTRACT

Flexible door for accessing a seat unit for an aircraft passenger, in particular for an aeroplane passenger. The flexible door includes a plurality of parallel slats, articulated longitudinally with respect to one another and connected transversely by at least one tensioner providing flexibility to the door.

### CROSS REFERENCE TO RELATED APPLICATIONS

This application is a National Stage of International Application No. PCT/FR2023/050736, having an International filing date of 24 May 2023, which designated the United States of America, and which International Application was published under PCT Article 21 (2) as WO Publication No. 2023/227850, which claims priority from and the benefit of French Patent Application No. 2205029 filed on 25 May 2022, the disclosures of which are incorporated herein by reference in their entireties.

### BACKGROUND

### Field

The present disclosure belongs to the field of seats for transport vehicle passengers, in particular for airline passengers, and more particularly relates to a flexible door for an aircraft seat.

The present disclosure applies directly, but not exclusively, to the layout of a business class of an airliner.

### Brief Description of Related Developments

Passenger comfort is an essential component in the design of an aircraft seat, especially when the aircraft proposes an improved comfort class, such as business class. Nevertheless, airlines that use aeroplanes, often try to maximize the occupation capacity of the cabin for better profitability of flights, while maintaining an adequate level of comfort.

This objective leads companies to turn towards densified cabin layouts, including in business classes, wherein the superior comfort seats, in particular those that can be converted into beds, are arranged more or less ingeniously to obtain the greatest possible density for a given level of comfort.

Regardless of the proposed layout, the seats are disposed according to successive transverse rows along the part of the cabin concerned by said layout. The pitch between these rows defines the spacing between two successive seats and therefore the passage width for the passenger.

This longitudinal spacing, called “seat pitch” or simply “pitch” in specialist jargon, is subjected to regulatory requirements in terms of dimensions and must enable passengers to access the seat and exit it without difficulty.

To this end, the regulations define minimum values of the access width to the passenger seat. Depending on whether or not the seat unit comprises a door, the minimum passage widths may vary.

Thus, in a seat unit 1, such as that of the prior art shown in FIGS. 1 and 2, the width of the passage and therefore the size of the door 2 conditions the pitch and the maximum density in the cabin.

Indeed, when the seat unit has direct access (one passenger not passing in front of another to get to their seat), it is equipped with a door.

In known solutions, the doors are rigid and often slidably mounted in a shell of the seat unit.

With reference to FIGS. 1 and 2, each door 2 slides in a shell 3 that inevitably has a sufficient size to receive said door.

Insofar as the door 2 must be able to almost completely retract into the shell 3 to clear the passage, when it is in open position as shown in dashed lines in detail A of FIG. 2, the shell 3 has a dimension in the sliding direction of the door at least equal to that of the door in the same direction.

The rigid nature of the door therefore does not make it possible to reduce the dimension of the shell on which the maximum density of the cabin depends. Therefore, it becomes problematic with this conventional design to increase the density of the cabin while maintaining a regulatory passage width.

For example, for qualification reasons, the minimum passage width must be 15″ above 25″ in height and 9″ below this height.

This problem of size of the rigid sliding doors has been encountered in other fields and has made it possible to develop flexible doors, consisting of parts articulated with one another, that can be stored in small spaces by bending or by rolling up like roller blinds.

One of the very first patented flexible doors, was the door described in the 1893 patent U.S. Pat. No. 490,448. Indeed, this concerns a door consisting of a plurality of articulated parallel slats enabling it to roll up around a vertical roller.

The use of such flexible doors with articulated slats is known in various applications. Such doors are for example described in the documents U.S. Pat. No. 4,432,591 and US20080272617.

However, these doors are not transposable as are in the aeronautical field for equipping seat units for the following reasons.

On the one hand, they would require guides and a specific rolling mechanism to open them and close them, either manual and therefore laborious and not suitable for business class in aeroplanes, or automatic and therefore very expensive.

On the other hand, they would require a storage box certainly of small dimension depending on the axis of the door, but of significant thickness as opposed to the thin shells generally used in the seat units for an aeroplane.

For all these reasons, no earlier solution proposes using a flexible door in a seat unit for an aeroplane.

Apart from the restricted space between rows, another problem of rigid doors is the blockage in the event of emergency evacuation. Indeed, in a movement of panic, a passenger may block the sliding of the rigid door. To prevent this blockage in the event of evacuation, the rigid doors are provided with an emergency system.

### SUMMARY

The aim of the present disclosure is to mitigate the drawbacks of the prior art described above and proposes an innovative door for increasing the density of an aircraft cabin while maintaining the comfort of the passengers and respecting the regulatory passage and pitch widths.

Another advantage of the disclosure is to overcome emergency systems for the emergency evacuations, the passenger indeed being able to pass through the closed door, such as a “saloon” door.

To this end, the object of the present disclosure is a door for accessing a seat unit for an aircraft passenger, in particular for an aeroplane passenger, including a plurality of slats articulated with respect to one another and connected by at least one tensioner, providing flexibility to said door.

Such a flexible door makes it possible for example to have a regulatory passage of 9 inches (because greater than 7 inches) and suitable for the comfort of business classes. Thus, this width brings the pitch of 38 inches to 33 inches in some cabin arrangements and therefore makes it possible to increase the density of the cabins.

Advantageously, the slats are juxtaposed in parallel and articulated along the lengths thereof.

According to one aspect, at least one tensioner is placed at each end of said door.

According to one aspect, the door further includes a runner at each end of each slat, passed through by at least one tensioner.

Each tensioner is for example an elastic rod having a sufficient length for connecting all the slats.

According to one aspect, the adjacent slats are separated by a gap over most of the length thereof.

Another object of the present disclosure is a seat unit for an aircraft passenger, in particular for an aeroplane passenger, comprising a flexible door such as shown.

More particularly, in such a seat unit, the door is preferably slidably mounted between two parallel and curved panels of a shell.

Alternatively, the door may be opened by bending, under the action of a push, without sliding.

Another object of the present disclosure is an arrangement of an aircraft cabin, comprising at least one seat unit as shown.

The fundamental concepts of the disclosure having just been explained above in their most elementary form, other details and features will emerge more clearly upon reading the description which follows and with reference to the appended drawings, giving as a non-limiting example an aspect of a flexible door in accordance with the principles of the disclosure.

### BRIEF DESCRIPTION OF THE FIGURES

The figures are given purely by way of illustration for better understanding of the disclosure without limiting the scope thereof. The various elements may be shown schematically and are not necessarily to scale. In the set of figures, identical or equivalent elements bear the same numerical reference.

It is thus illustrated in:

FIG. 1: (already mentioned) a perspective view of two seat units of the prior art each equipped with a conventional sliding rigid door;

FIG. 2: (already mentioned) a detailed top view of FIG. 1;

FIG. 3: a front view of a flexible door according to one aspect of the disclosure;

FIG. 4: an indented partial view of the flexible door, showing tensioners passing through the runners of the slats;

FIG. 5: a partial top view of a seat unit with the flexible door in normal closed position;

FIG. 6: a partial top view of a seat unit with the flexible door in normal opened position;

FIG. 7: a detail of FIG. 6, showing the curvature of the door after closing;

FIG. 8: a perspective view of a seat unit with the flexible door in emergency opened position;

FIG. 9: a top view of FIG. 8;

FIG. 10a: a perspective view of a flexible door in closed position, according to one aspect of the disclosure;

FIG. 10b: the flexible door of FIG. 10a in outwardly open position;

FIG. 10c: the flexible door of FIG. 10b in inwardly open position.

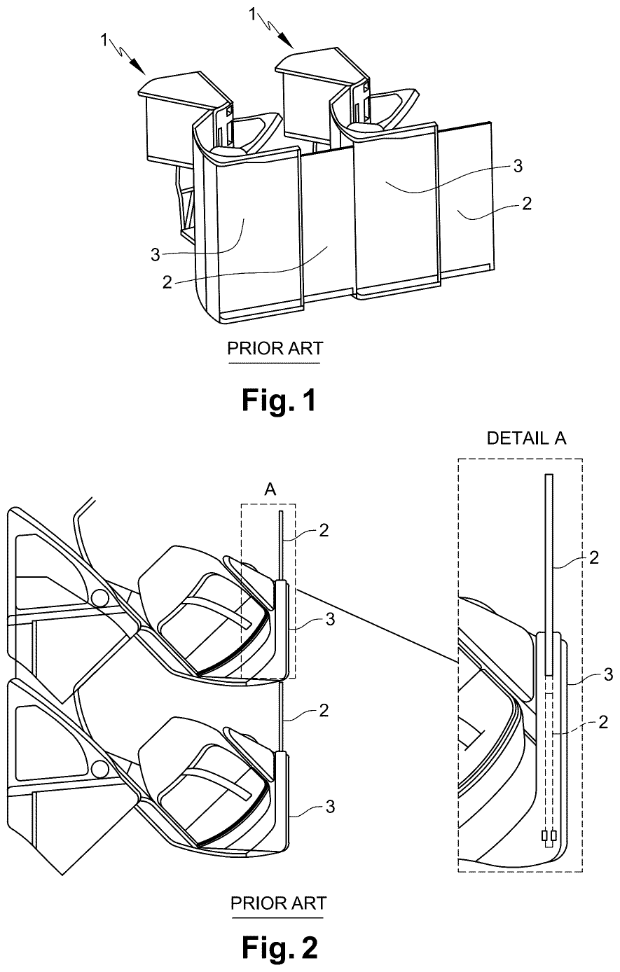

### DETAILED DESCRIPTION

In one aspect described below, reference is made to a flexible door of a seat unit for an aircraft passenger, mainly intended for units with seats that can be converted into beds generally equipping the business classes of airliners. This non-limiting example is given for better understanding of the disclosure and does not exclude using the flexible door in another transport vehicle that is suitable for seat arrangements similar to those of aeroplanes.

In the present description, the term “flexible” designates the capacity of a structure to allow itself to be deformed with a very large amplitude and to return to its equilibrium position in the absence of a bending force.

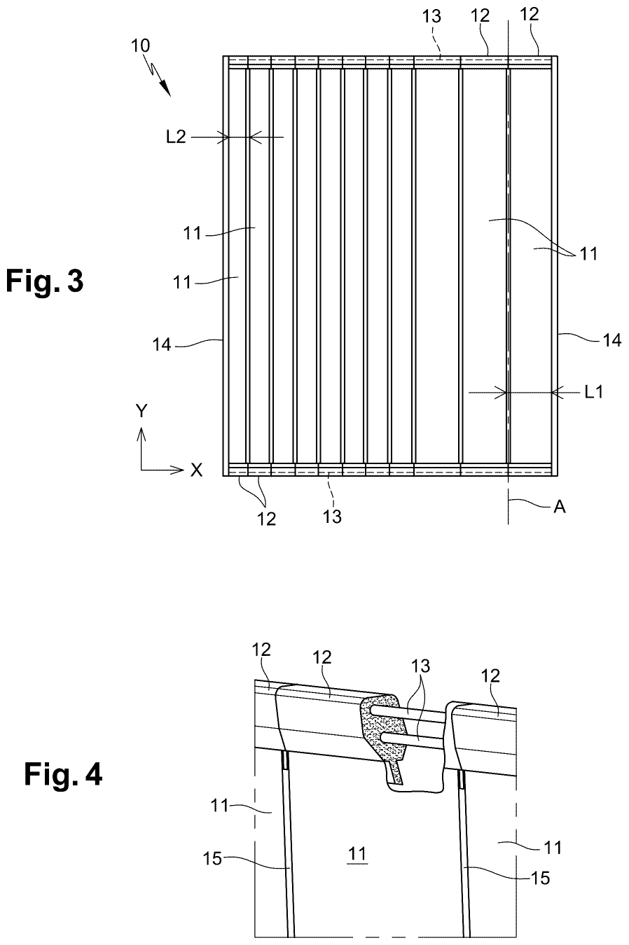

FIG. 3 shows a flexible door 10 comprising a plurality of slats 11 juxtaposed in parallel and articulated with respect to one another by the longitudinal sides thereof (along the Y-axis) for providing a transverse suppleness (that of the door, of the runners 12 at the rate of two per slat 11 at the ends of the latter, and of the tensioners 13 each passing through the same row of adjacent runners 12 to provide a transverse elasticity to the door 10 counteracting the suppleness thereof and thus providing thereto the flexibility thereof.

Indeed, in each pair of adjacent slats 11, the slats are articulated about a common longitudinal axis A substantially merged with the longitudinal sides close to said slats, so that the various axes of articulation are transversely offset (along the X-axis) and imply a kinetics of the “articulated arm” type with the door 10. The relative movement of the slats 11 is not totally free and remains restricted by the tensioners 13 that exert a return force on each slat 11 to bring the door 10 back to the rest position thereof that is an unbent position.

FIG. 4 makes it possible to view the tensioners 13 passing through the same row of runners 12. In this example, the flexible door includes two tensioners 13 per row of runners 12, i.e. Four tensioners in total, two at the lower end and two at the upper end of the door.

The tensioners 13 extend over the entire width of the flexible door 10 so as to provide flexibility at each slat 11. In addition, each set of tensioners 13 placed at the end of the door 10 have the same Young's modulus of elasticity (or stiffness) so that the bending of the door is not accompanied by a torsion, in other words so that the door 10 does not twist when a passenger pushes it.

Of course, the elasticity level sought for the flexible door 10 depends on the modulus of elasticity resulting from each set of tensioners 13, said resulting modulus itself depending on the number of tensioners of the same nature in each set.

According to the example illustrated, each tensioner 13 is a flexible rod of circular straight section that inserts into suitable passages arranged in the body of the runners 12.

Each runner 12 is securely attached to one end of a slat 11 by any suitable attachment means.

Alternatively, each slat may be produced in one piece with two end runners thereof. For reasons of easy maintenance and replacement, it is nevertheless preferable that the slats 11 are independent and separable from runners 12.

The slats 11 are for example in the form of rectangular thin slats and have a sufficient mechanical strength so as not to individually deform during the use of the flexible door 10.

Furthermore, a gap 15 remains between the adjacent slats 11 in order to facilitate the mutual articulation thereof, reduce the contact wear thereof as well as the noise produced by the movement thereof.

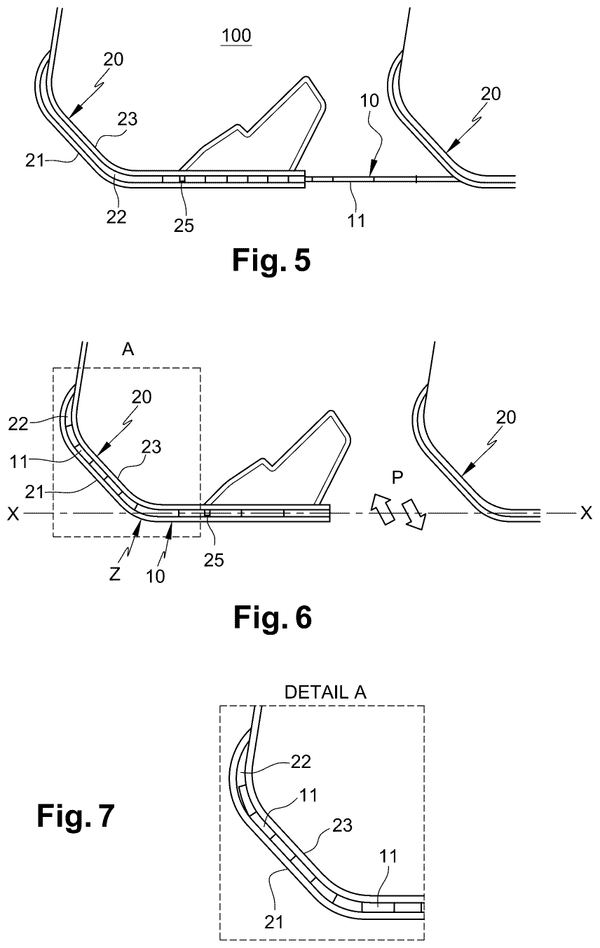

FIG. 5 shows the flexible door 10 installed in a seat unit 100 of the type comprising a seat that can be converted into a bed and various amenities generally proposed to business class passengers.

The seat and the amenities of the seat unit are not the object of the present disclosure and therefore will not be described. Only the outer shell of the seat unit participates in the operation of the flexible door and will be described in this respect.

Indeed, the seat unit 100 is externally covered by a shell 20, generally in the form consisting of flat portions extending in rounded or successively broken portions, with which the flexible door cooperates 10.

More precisely, the flexible door 10 is slidably mounted within the shell 20 between two parallel panels of said shell: an outer panel 21 and an inner panel 23, such as a conventional pocket door.

The panels 21 and 23 are moved apart and define an inner space 22 wherein the flexible door 10 totally or partially fits depending on whether it is in open, slightly open or closed position.

In FIG. 5, the flexible door 10 is in closed position and totally seals off the passage by abutting against the shell 20 of the seat unit located immediately in front of the seat unit 100 to which said door belongs. In this closed position, the slats 11 are substantially coplanar so that the door 10 remains globally planar and has a first part, concealed, trapped in a flat portion of the shell 20 and a second visible part, protruding from said shell and abutting against the shell in front.

The flexible door 10 may of course include any gripping means such as a handle, protruding or hollow, to enable a user to slide it along the shell 20 between the closed position and the open position and vice versa.

The seat unit may also include a control button for automatically opening and closing the flexible door 10.

The sliding of the flexible door 10 is carried out by means of one or more rollers 25 in contact with the lower and/or upper runners 12.

FIG. 6 shows the flexible door 10 in an open position, completely open, which releases the passage P for entering and exiting the seat unit 100. In this open position, the flexibility of the door 10 enables it to be inserted into the curved and inclined portions of the shell 20 to be totally stored therein. Therefore, this enables the door 10 to occupy a part of the storage space 22 that does not extend in the same direction X as the flat portion of the shell 20 close to the passage P, so as to limit the extension of the shell 20 in said direction while maintaining a minimum regulatory width for the passage P.

Thus, an aeroplane cabin may receive more seat units each equipped with a flexible door according to the disclosure than seat units each with a conventional rigid door.

When a user opens the flexible door 10, this slides from the outside to the inside of the shell 20 by being guided by the curvature of the panels 21 and 23. To this end, the slats 11 of the door 10 are narrower on the part thereof, referred to as distal, intended to penetrate into the curved portion of the shell 20 wherein some bending areas are significantly curved. The small width of the slats 11 in this distal part of the door 10 makes it possible to prevent the bracing thereof in the bending areas Z of the shell 20 during the sliding of the door.

FIG. 7 that is a detail of FIG. 6 clearly shows that the small width of the slats 11 makes it possible to slide the flexible door in the inner space 22 that is reserved therefor between the curved panels 21 and 23 of the shell.

Conversely, the slats 11 of the other part of the door 10 close to the passage P, referred to as proximal, have a larger width. More precisely, the width of the slats 11 progressively decreases from the proximal part to the distal part.

This variation is clearly shown in FIG. 3 with a larger width L1 and a smaller width L2.

The large width of the slats 11 of the proximal part indeed facilitates the opening of the door 10 in the event of emergency evacuation, the passenger being led to frontally push the door.

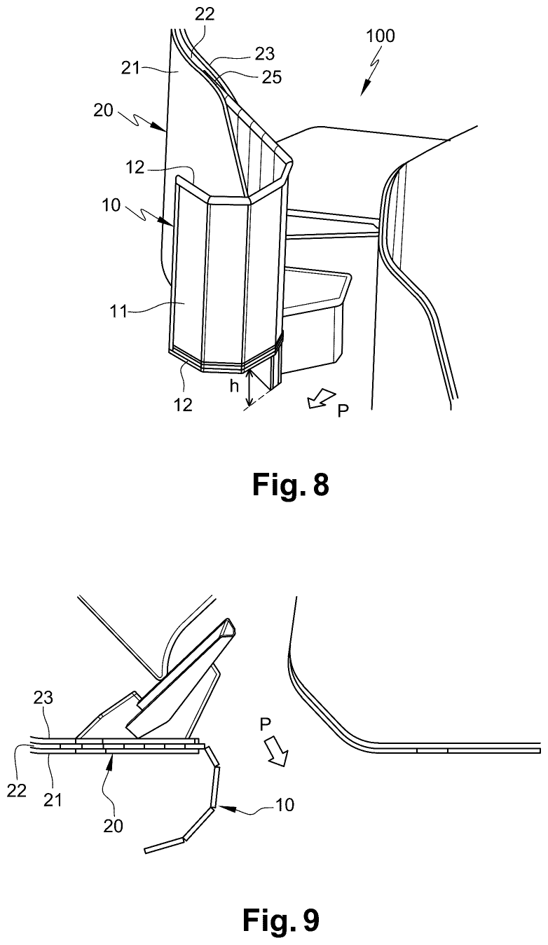

FIGS. 8 and 9 show, in perspective view and in top view respectively, the flexible door 10 such that it would be deformed by a frontal push by the passenger, in particular in the event of emergency evacuation.

The flexibility of the door 10 obtained by the articulated slats 11 and the tensioners 13 enable it to behave as a “saloon” swing door, known quite rightly for the facility thereof to open and close.

The flexible door 10 was designed to comply with all regulatory requirements in force, just as well for the structure thereof and the manufacturing materials thereof and for the layout thereof in the seat unit 100. For example, when it is installed in the shell 20, the door 10 is raised by a height h in relation to the floor of the cabin.

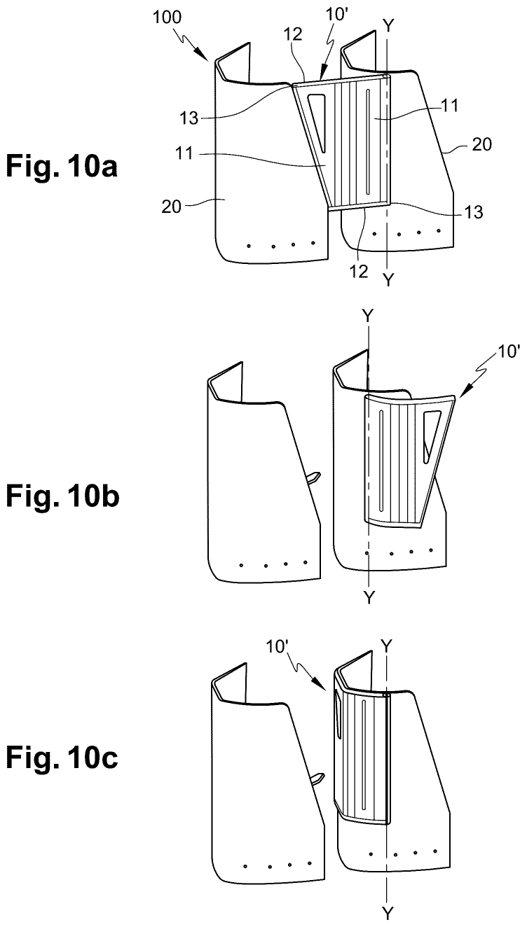

FIGS. 10a to 10c show a flexible door 10′ according to another aspect, wherein said door is not slidably mounted in the shell of the seat unit of which it conditions the passage, but embedded in the shell of the seat unit located immediately in front.

Indeed, the flexible door 10′ is embedded along a vertical Y-axis on a shell 20 located in front of the seat unit of which the access is ensured by said door. This embedment makes it possible for the flexible door 10′, thanks to the flexibility thereof, to pivot in relation to the Y-axis.

With reference to FIG. 10a, the flexible door 10′ includes, as in the first aspect, a plurality of articulated slats 11, runners 12 attached to the ends of the slats, and tensioners 13 passing through the runners.

The flexible door 10′ is attached to the shell 20 by way of an embedment element not shown whereon the first slat 11 is articulated.

In order to adapt to a particular geometry of the spacing between the two successive shells 20, the slats 11 have shapes adapted to contour the shape of the spacing in closed position. Thus, an end slat 11 has an inversed triangle shape to correspond to the inclined edge of the shell 20 while being vertically articulated with the adjacent slat that is of rectangular shape.

FIGS. 10a, 10b and 10c show the door 10′ respectively in a closed position, in an outwardly open position when the passenger leaves the seat unit, and in an inwardly open position when the passenger accesses the seat unit.

According to this aspect, the normal operation of the flexible door 10′ is closer to the operation of a “saloon” door.

What is claimed is:

1. A flexible door for accessing a seat unit for an aircraft passenger, in particular for an aeroplane passenger, characterized in that it includes a plurality of slats articulated with respect to one another and connected by at least one tensioner, providing flexibility to said door.

2. The flexible door according to claim 1, wherein the slats are juxtaposed in parallel and articulated over the lengths thereof.

3. The flexible door according to claim 1, wherein at least one tensioner is placed at each end of said door.

4. The flexible door according to claim 1, further including a runner at each end of each slat, passed through by at least one tensioner.

5. The flexible door according to any claim 1, wherein each tensioner is an elastic rod having a sufficient length for connecting all the slats.

6. The flexible door according to claim 1, wherein the adjacent slats are separated by a gap over most of the length thereof.

7. A seat unit for an aircraft passenger, in particular for an aeroplane passenger, characterized in that it comprises a flexible door according to claim 1.

8. The seat unit according to claim 7, wherein the flexible door is slidably mounted between two parallel and curved panels of a shell.

9. The seat unit according to claim 8, wherein the flexible door opens by bending under the action of a push, without sliding.

10. An aircraft cabin layout, in particular for an aeroplane, comprising at least one seat unit according to claim 7.
